(19) United States
(12) Patent Application Publication
(10) Pub. No.: US 2003/0167334 A1
(43) Pub. Date: Sep. 4, 2003

(54) Provision of content to a client device

(76) Inventor: Mark Henry Butler, Bristol (GB)

Correspondence Address: IP Administration, C/o Hewlett-Packard Company, Mail Stop 35, 3404 East Harmony Road, Ft. Collins, CO, 80528-9599, US

(21) Appl. No.: 10/350,439

(22) Filed: Jan. 24, 2003

(30) Foreign Application Priority Data
Jun. 18, 2002 (GB) 0213943.4
Mar. 4, 2002 (GB) 0204993.0
Mar. 4, 2002 (GB) 0204994.8

(51) Int. Cl. G06F 15/16

(52) U.S. Cl. 709/227

(57) ABSTRACT

Content accessible to a variety of client devices from a web page is associated with machine readable labels setting out capabilities required by a client device in order to manifest the content in a meaningful manner. Several versions of the content may be provided by the author, each version of the content being associated with its own specification of client device capabilities required to manifest it. The capabilities required are matched with the technical attributes of a client device, in order to establish which version of the content to provide to a client device.

### BACKGROUND TO THE INVENTION

1. Field of the Invention

The present invention relates the authoring of material such as, for example, literature, photographs, drawings, music, cinematographic works, or any other form of work, and to the dissemination of such works via an information technology network to a variety of technically different devices whose function is to manifest the works in a manner which enables a user to assimilate them.

To be able to disseminate such works via the world-wide web (for example), the works themselves must be recorded in a material form which enables them to be copied and transmitted via the telecommunications links which form the Internet; currently in the form of electronic files. Such electronic files frequently incorporate machine readable labels whose function is to provide structure to the files, for the purpose, inter alia of reflecting the semantic structure inherent within the works which the files serve the function of storing. These machine readable labels are almost always invisible to a consumer of the work, but serve the purpose of enabling computational operations to be executed upon the files.

For example, consider the case of a book, stored in the form of an electronic file and hosted on a server, and a client device which may manifest the book for assimilation via the medium of Braille. In this example, the client device has only a small memory, and so is incapable of storing the electronic file in its entirety. If a download of the file from the server to the client device is requested using this device, the download will be interrupted at the instant the memory of the device is full, i.e. part way through the file, and therefore part way through the book. In the absence of machine readable labels within the file denoting, say, the locations within the electronic file of chapters of the book, it will be impossible for a user of the client device ever to download the remainder of the book. This is because electronically the book is monolithic and therefore has no chapters or other structure. Consequently neither the client device nor the server hosting the book have any way of being able to establish which part of the Braille file was not downloaded. A further download request will therefore once again start to download the entire book from the beginning, and will once again terminate due to lack of memory in the client device at the same place in the file (and therefore the book) as a before. However, once machine readable labels reflecting for example the locations of each chapter within the book are incorporated within the file in which the book is stored, it is possible for both the client device and the server to establish that the download of, say the first five chapters of the book were successfully completed, and so to arrange on the second occasion to download chapters 6 et seq.

The work itself (in this example the words of the book, or in the case of a picture the image), the material form in which it is recorded such as an electronic file, and any machine readable labels incorporated within it, together are known as “content”, typically because they form the content of one or more web pages. It is currently possible to gain access to the content of a web page hosted on a web server using a number of different client devices. Examples of such client devices include a desktop or laptop computer, a personal digital assistant (PDA) in combination with a telephone and modem link, or a Wireless Access Protocol (WAP) enabled mobile telephone. Thus, in principle, content posted on a web page, such as text and graphics is accessible by a consumer in possession of any one of these client devices who is able also to avail themselves of the requisite network links. In practice however a significant but, to the lay person ostensibly trivial difficulty exists in disseminating content to all of these devices in a manner which is useable by a consumer: the client device the consumer is using to make manifest the content may not be capable of manifesting elements of the content essential for comprehension of the information within it. Specifically for example a web page may not have been authored specially to enable viewing of its content via WAP, i.e. typically using a small, monochrome and extremely low resolution screen. If the author has therefore created the web page so that all or part of the essential information on the page required by the user is “coded” in the form of photographs, coloured text or animations, then a user who is unable to display these elements of the content on their screen will be unable to interpret their meaning, and is therefore effectively unable to access the page in any meaningful manner.

2. Description of Related Art

While this is a known problem, there is currently no widely accepted manner of overcoming it. One approach involves the use of a system of classification of various client devices according to their various technical attributes, known as “device classes”, which are then used to provide information to enable a transformation of one or more elements of the content into an appropriate form for the client device requesting the content. An example of this approach, in which the requested content includes text and machine readable labels in the form of “tags” written in Extensible Markup Language (“XML”), works as follows. On requesting a page a client device identifies itself to the hosting web server using what is known as a “user agent string”. On receipt of the user agent string, the hosting server queries a database in order to obtain the appropriate device class for the client device, and retrieves a series of rules and templates which govern the transformation of the content which must be performed in order to make the content properly manifestable by that device class. These rules and templates are known as a “stylesheet”, and the stylesheet is written in Extensible Stylesheet Language (XSL). The stylesheet is then applied to the content and operates upon the XML tags to generate a version of the content specialised for the device class of the requesting client device (sometimes known as “rendering” or content specialisation).

There are a number of problems with this approach to content specialisation. Firstly, while the user agent string is notionally unique to a given make and model (e.g. in the case of hardware) or version (e.g. in the case of software) of a client device it is frequently the case that a client device will adopt the user agent string of a different device when requesting a web page in order to attempt to ensure that the server sends the correct version of the content desired by the requesting consumer. Thus for example a particular web browser programme may represent itself to the server as a different browsing programme by using its user agent string. In order to ensure that the correct device class is retrieved from the database (necessary because the capability of the device is determined both by its hardware as well as its software) and the appropriate stylesheet is applied to the content therefore, the user agent string must be carefully examined in order to ascertain the genuine identity of the requesting client device. A further problem is that the device class approach rapidly becomes difficult to manage when the number of device classes is large. As mentioned above, each device class may be thought of as a single combination of a variety of technical attributes, and attributes may have many technical “levels”. For example, while some of these technical attributes are simply either present or not (such as for example colour screen=“YES” or “NO”), others are specified by a level or number, such as “screen size”, e.g.=“256×256, but could in theory be any one of a large number of alternative sizes, and therefore potentially give rise to a large number of possible attribute “levels”. This means that the number of possible permutations of device class, which in essence is the number of different possible permutations of the individual technical attributes of known devices, increases rapidly when the number of technical attributes specified by level or number increases. Since a separate stylesheet is required for each device class, it soon becomes impractical to employ device classes when the number of technical attributes required to specify a device class is large, since the number of stylesheets which the server must support in order to serve all the device classes with those attributes is correspondingly large.

### SUMMARY OF THE INVENTION

A first aspect of the present invention provides an alternative approach, in which the capabilities required by a client device in order to manifest content from a web page in a meaningful manner are specified with reference to the content of the web page, and these requisite capabilities are then compared with the technical attributes possessed by the client device to determine if they are present in the client device. Typically content will be made available in the form of several versions, with a corresponding class of requisite client device capabilities being specified for each version, and the appropriate version of the content for a particular client device being determined on the basis of whether the capabilities specified for that version are possessed by the client device, which is in turn determined by comparing the requisite client device capabilities specified for that version with the technical attributes possessed by the client device.

In one example, content on a web page may be considered in component parts, and for each component part the capabilities a client device must have in order to manifest that component of content are established. These client device capabilities are typically included within the content components of the web page in the form of machine readable labels (although alternatively they may be retained elsewhere in a manner which nonetheless identifies them as being connected to the content component to which they relate).

Typically, although not necessarily, in accordance with currently established protocols, when a request for a page is received from a client device, the request is accompanied by a detailed list, or “profile” of the client device's technical attributes. This profile is processed to aggregate the technical attributes of the client device, detailed individually within the profile, into groups which correspond to the requisite client device capabilities that have been specified in relation to the content of the web page, in order to enable a comparison between the specified client device capabilities required to manifest the content, and the technical attributes actually possessed by the client device. As a result, it is then possible to consider the technical capabilities of the client device specifically vis a vis the capabilities required to manifest content of the requested page.

The term “capability” or “capabilities” is intended to be applied broadly, to include within its scope (but not to be limited to): simple technical attributes, such as for example a specified screen size of 60×60 pixels: a specified technical attribute in conjunction with one or more conditions which must be met in respect of that attribute, such as for example “screen size 60×60 pixels”, and the condition may be “greaterthan”, meaning that in this example the client device capability required to manifest the image is a screen size of greater than 60×60 pixels; or combinations of technical attributes, such as the ability to display moving images, in combination with the ability to manifest colour, for example, whether also in conjunction with a condition or not.

As mentioned above, content may be made available in several versions, with the nature and number (including whether more than one version is made available at all) of the versions being at the discretion of the author of the web page, with each range of client device capability corresponding to a given version, and being known as a “capability class”. Thus for example, in the instance where client device capabilities are specified for component parts of content, provision may be made to provide an image on a web page to a client device in three possible versions, with the capability classes defining the client device capabilities necessary to manifest each version and being specified within the machine readable labels associated with that image. Different versions of content are provided in different ways depending upon the nature of the content component, so that for example in the case of a text-based content component, different versions may be provided by applying stylesheets to a single file containing text. In the case of images or sound on the other hand, different versions may be provided either by storing and dispatching copies of alternate image files, or by modifying an image file using a process known as transcoding. An advantageous aspect of the use of capability classes is that client devices are either capable in a given capability class (i.e. have all of the technical attributes necessary to manifest a given version of a component of content in a meaningful manner) or not. Thus for example, in accordance with one embodiment, if a client device has technical attributes which for example match four of the requirements specified in the capability class associated with a content component of a web page, but not a fifth, then the client device is not capable in that class, and the server then attempts to map a lower capability class associated with the content component of the web page to the client device. The result of this is that the proliferation of permutations which occurs in relation to a classification system based on attributes of the client device is dramatically reduced. A further advantage is that the degree of resolution across a range of different capabilities is entirely within the control of the provider of the web page; they are able to cater for as many or as few different capability classes, and therefore provide content which is as appropriately matched to a wide range of client devices as they wish, and yet still retain the opportunity to dispatch content in some form or other to the full range of devices.

### BRIEF DESCRIPTION OF DRAWINGS

An embodiment of the present invention will now be described, by way of example, and with reference to the accompanying drawings, in which:

FIG. 1 is a representation of a web page, and the capability classes defined for content components thereof,

FIG. 2 is a schematic illustration of a process in which a client device profile is provided to a web server;

FIG. 3 is a schematic diagram of the transmission to a web server of a client device profile, and the process of matching that profile to an appropriate capability class;

FIG. 4 is an XML file in which a number of examples of capability classes are specified; and

FIG. 5 is an XML file in which a number of examples of transcoding are illustrated.

### DESCRIPTION OF PREFERRED EMBODIMENTS

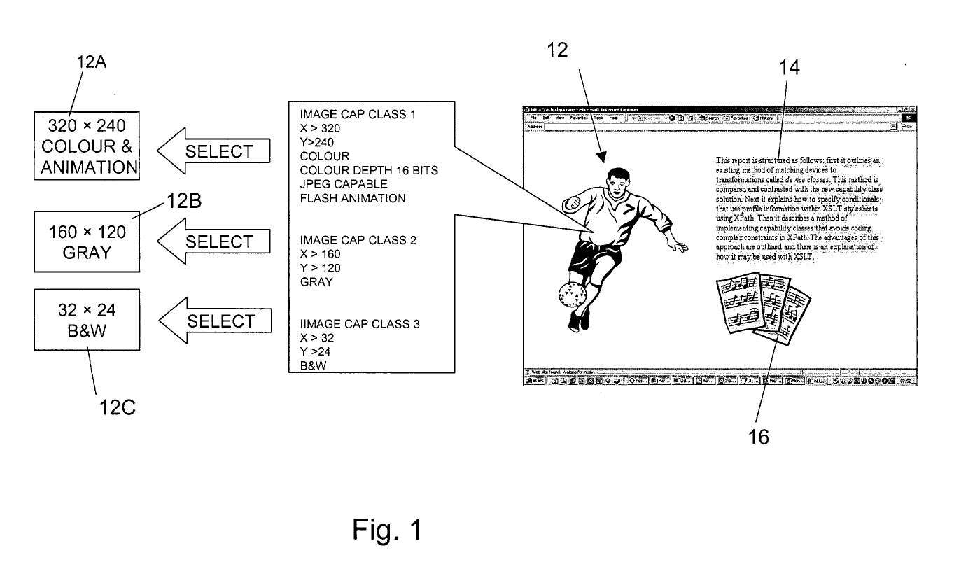

Referring now to FIG. 1, a web page 10 comprises three components or elements of content: an image 12, text 14, and sound 16; a component of content may be thought of as being a piece of content which is capable of independent manifestation, manipulation or other processing (although this is not intended to be an exclusive definition). Considering initially the image 12 in detail, in order to enable manifestation of the image by a range of client devices, that is to say client devices having differing technical capabilities, the web page 10 is configured to make available different versions of the image, and in the present example these different versions are provided simply in the form of alternate images. The alternate images and their attributes are schematically represented in FIG. 1 as: an image 12A, which is a colour image in Joint Photographic Experts Group (“jpeg”) format of size 320×240; image 12B: a grey image of size 160×160; and image 12C: a black and white image of size 60×60. When the page is authored, part of what may be thought of as the authoring process involves specifying the capabilities that a client device will require in order to display each of the alternate images 12A-C. When the necessary capabilities for each alternate image are grouped together, they may be thought of as a class of capability (or in shorthand “capability class”) necessary for manifesting that alternate image.

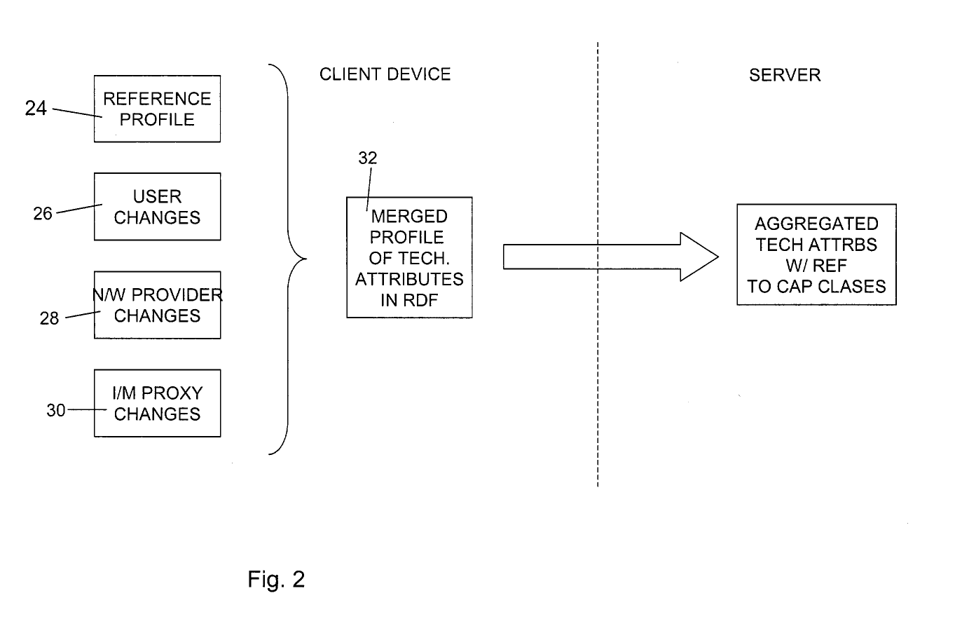

Referring now to FIG. 2, when a client device 20 contacts a web server 22 and makes a request for a web page in accordance with hyper text transfer protocol (“http”) the client device transmits a detailed list of its technical attributes to the server 22, known as a profile. The profile is actually a combination of individual profile elements, including a reference profile 24, which is effectively the profile describing the client device “out of the box”, i.e. in its default factory settings, a user changes profile 26, in which any customisation of the device implemented by the user is specified, a Network Provider profile 28, in which changes resulting from actions of the network provider are specified, and an Intermediate Proxy profile 30 specifying changes as a result of actions by any proxy for the client device. The individual profile elements are combined and passed to the server 22 as a merged profile 32 of attributes, usually in RDF syntax and in the form of an XML document. The server 22 creates from this merged profile 32 groups of aggregated technical attributes corresponding to the client device capabilities specified in the capability classes for the content components of the web page.

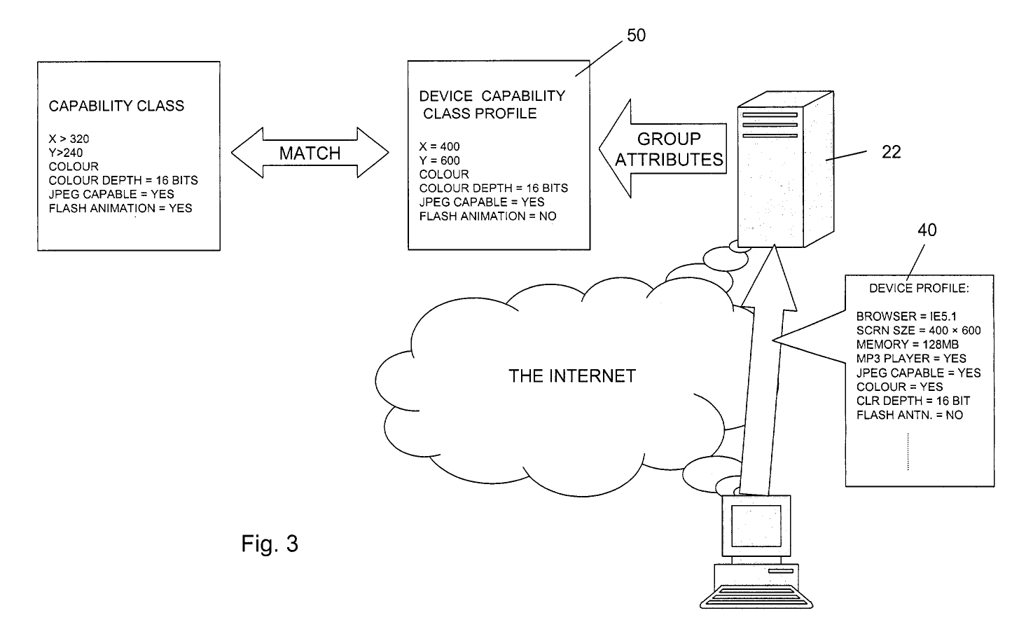

Referring now to FIG. 3, this process is illustrated in more detail for the image 12. An extract 40 of the merged profile 32 is illustrated in FIG. 3, the extract here being simply part of the full merged profile, since typically the full merged profile 32 of the client device may comprise as many as, say, 50 or more attributes. Those attributes illustrated in the extract 40 of the merged profile 32 include the version of the web browser, the screen size of the device in pixels, the memory size, whether the device is capable of playing an MP3 file, whether the device is capable of assimilating images in jpeg format, whether the device is a colour device, the colour depth of the device in bits, and whether the device is capable of assimilating flash animation. On receipt of the entire merged profile 32 (i.e. not just the illustrated extract), the server 22 processes the profile, and this process may be thought of conceptually as generating groups of attributes from the merged profile which match those capabilities specified in the capability classes provided for each of the content components of the web page 10. Thus, in the case of the image 12, as seen in FIG. 1, the capability class for the preferred alternate (i.e. the best image quality) image 12A-C includes a given screen size, colour capability, a predetermined colour depth, jpeg capability, and flash animation. The server 22 therefore “extracts” or groups the technical attributes of the device profile 40 in which screen size, colour capability, colour depth, jpeg capability and flash animation capability are specified (whether solely and/or explicitly, or as part of some other attribute perhaps), to generate what can be thought of as a capability class profile 50 of the device, i.e. a profile of device attributes corresponding generically to the capabilities in the capability classes and which therefore enable an assessment of which capability class the device falls into. Having done this it is possible for the server to determine whether the technical attributes of the capability class profile of the device match the capability class specified for the best quality alternate image 12A. As can be seen from an illustration of the matching process in FIG. 3, the capabilities of the client device do not include flash animation capability, and so it is not possible for the client device to display the preferred and highest quality alternate image 12A. The server 22 therefore matches the capability class specified for the next preferred image, the grey image 12B, and it can readily be seen that this capability class is met by the client device capability class profile, meaning that the server 22 therefore dispatches the alternate image 12 B to the client device.

Thus, in the above-described embodiment, those client device capabilities which are to be used as a reference for the process of providing appropriate content to a client device are specified with reference to the content components of the web page. This has several advantages. Firstly, the author of the page is able to decide for example how many versions of (say) an image they wish to provide, rather than this being driven by the proliferation of device classes (the more versions that are provided, the greater the likelihood that a client device will receive a version of the image which is able to make full use of its capabilities, in contrast to the example given above, in which a lack of flash animation capability meant that a device which was colour and jpeg capable, with a sufficiently large screen was sent an image of a much smaller size in grey). Secondly, a server is able to provide appropriate content to a client device which it has not encountered before and whose user agent string does not match any device class stored within its database (in which circumstance, according to the device class approach, the server would have no way of being able to determine an appropriate version of the content for that client device).

The specific example of FIG. 3 is a simplification in a number of ways. Firstly the process of matching the client device profile to the capability class usually includes the use of a number of boolean operators. In fact this is implicit within the description of the example described with reference to FIG. 3 above, since the X and Y screen size values specified in the capability class for the image are not identical to those in the client capability class profile; the client device having a screen whose X and Y values are larger than those specified in the capability class. Secondly it may well be that the capability classes for given versions of a content component are all specified together, e.g. as an XML document, and within which boolean operands are embedded so that the matching process is effectively a single operation which returns the appropriate version of e.g. the image.

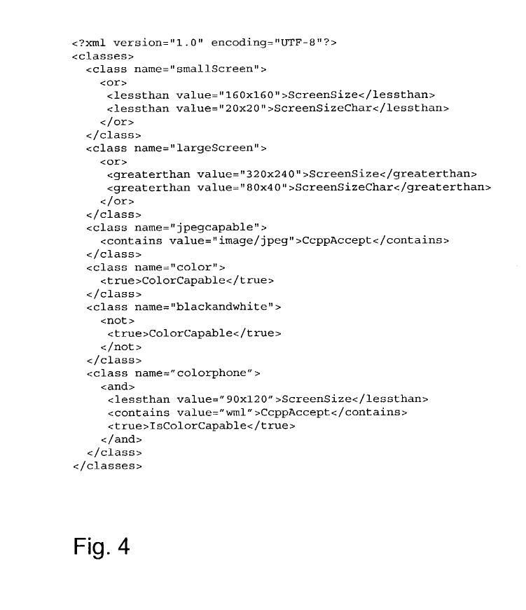

For example, and referring now to FIG. 4, an XML file defines four capability classes: smallScreen, largeScreen, jpegcapable and colour. In the case of smallScreen, the constraints are that the device has a screen smaller than 160 wide and 160 pixels high—or if it has a screen that is smaller than 20 characters wide and smaller than 20 characters high. Alternatively a device meets the jpegcapable capability class criteria if it can display the MIME type image/jpeg. It can therefore readily be seen that it is possible to use boolean operators to aggregate technical attributes, or to consider alternatives (e.g. in the case of the smallScreen capability where a device meets the capability when either of the two numerical values specified for screensize and character size exceed the device's capabilities) in order to return the appropriate capability class. The capability class file can contain three Boolean expressions for aggregating constraints: and, or and not. It provides a number of conditionals: lessthan, lessthanequals, greaterthan, greaterthanequals, equals, contains and true. Each conditional is only applicable to specific manners of describing capabilities as shown in the following table:

| Conditional | Compatible UAProf data types |
|---|---|
| Lessthan | number, dimension |
| Lessthanequals | number, dimension |
| Greaterthan | number, dimension |
| greaterthenequals | number, dimension |
| Equals | number, dimension, single literal |
| Contains | single literal, set of literals, sequence of |
| | literals |
| True | Boolean |

The example illustrated in relation to FIG. 3 illustrates the use of capability classes in relation to alternate images provided on a web page. The concept is however generally applicable to all forms of content, and to other manners of content specialisation (i.e. providing suitable versions of such content to a client device), and not just the use of alternates. Thus for example, in the case of the text on the web page, the specification of capability classes for displaying the text (for example because in accordance with one capability class the text is to be displayed on a coloured background) and the matching process will result in the selection of an appropriate XSL stylesheet to be applied to the text in order to provide the appropriate version of the text for the requesting client device. A stylesheet may be thought of as a collection of rules which may be applied to content (typically textual) in order to adapt it for a client device on which the content is to be manifested. The rules are embodied in the form of instructions which may be implemented by operating upon the machine readable labels (such as XML tags in the case of XSL stylesheets for example) embedded within the text, for the purpose of adapting the content by for example: re-ordering the textual content by moving blocks of text around (in each case identified by a pair of machine readable labels); removing blocks of textual content; or augmenting the content with a further block of textual content which is available when the stylesheet is being implemented. In order to adapt content for a given capability class, it is possible to use either a single stylesheet containing several alternate sub-stylesheets or “modes”, each of which is applicable for one of the capability classes. Where a single stylesheet having plural modes is employed, the rules within the stylesheet will govern which of the modes is used to adapt the content in dependence upon the capability class of the client device. Alternatively several stylesheets, each of which is applicable to a given one of the capability classes may be employed, with the appropriate stylesheet being implemented for the relevant capability class. Stylesheets and their implementation per se are well known and will therefore not be discussed further in the present application.

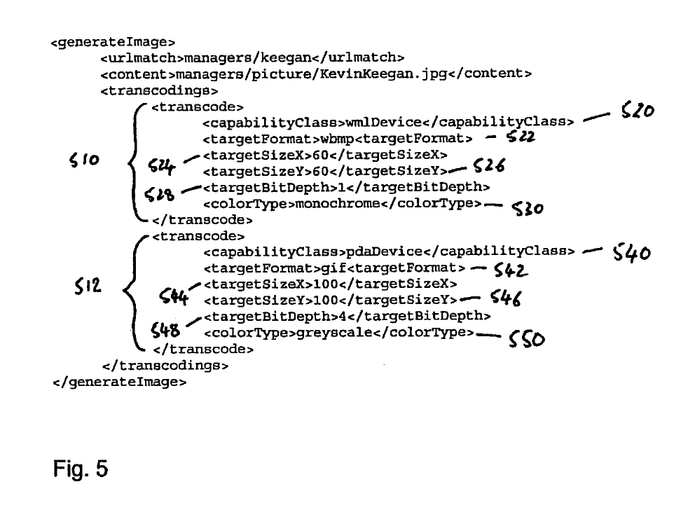

In the case of a sound file or video file, for example, the matching of a capability class results in the implementation of an appropriate form of a process known as transcoding, in which the sound or video file is adapted to the client device. The process of transcoding is known per se, and will now be illustrated in general terms with reference to FIG. 5. Transcoding instructions for adapting content are illustrated in an XML document in FIG. 5. In the example of FIG. 5, which does not relate to any of the content components illustrated or referred to in FIGS. 1 to 4, the transcoding instructions relate to a component of a web page which is a picture known by the epithet “managers/Keegan” (i.e. within a general class of images “managers” available from a web page, a given manager image “Keegan”). The instructions include two alternate transcodes, 510 and 512. If, as defined at line 520 of the document, the capability class of the client device corresponds to a class defined as “wmlDevice”, then the instructions set out in lines 522-530 are implemented to provide a suitable transcode of the image. the format will be wireless bitmap (line 522), the target size will be 60×60 (lines 524 and 526), and so on. Alternatively if as defined at line 540 of the document the capability class of the client device corresponds to the “pdaDevice” class, then the transcoding instructions set out at lines 542-550 are implemented, to provide the image in the form of a gif file, with a size of 100×100, a bit depth of 4, and in Greyscale.

1. A method of providing content to a client device comprising the steps of:
comparing a first class of capabilities required by the client device in order to manifest a first version of the content with technical attributes possessed by the client device;
establishing on the basis of the comparison whether the client device has the capabilities of the first class; and
in the event that the client device has the capabilities of the first class, dispatching the first version of the content to the client device.

2. A method according to claim 1 wherein, in the event the client device does not have the capabilities of the first class, comparing at least one further class of capabilities which are required in order to manifest at least a further version of the content with the aforesaid technical attributes, and in the event that the client device has the capabilities of at least one of the further classes, dispatching a corresponding further version of the content to the client device.

3. A method according to claim 1 wherein the content comprises a plurality of content components, wherein at least one class of client device capabilities is specified and compared to the technical attributes for each component.

4. A method according to claim 1 wherein an appropriate version of the content is provided by modifying existing content in a predetermined manner.

5. A method according to claim 4 wherein an appropriate version of the content is provided by applying a stylesheet to the content.

6. A method according to claim 5 wherein the stylesheet is selected on the basis of which class of client device capabilities matches the technical attributes of the client device.

7. A method according to claim 4 wherein an appropriate version of content is provided by transcoding the content.

8. A method according to claim 7, wherein a transcoding procedure is selected on the basis of which class of client device capabilities matches the technical attributes of the client device.

9. A method according to claim 1 wherein an appropriate version of the content is provided by selecting one of a plurality of existing alternate versions of the content.

10. A method according to claim 9 wherein the appropriate alternate version is selected on the basis of which class of client device capabilities matches the technical attributes of the client device.

11. A method of distributing content from a web page to a client device comprising the steps of:
specifying a first class of capabilities required by the client device in order to manifest a first version of the content;
comparing the first class of capabilities with technical attributes of the client device;
on the basis of the comparison, establishing whether the client device is able to manifest the content; and
if the client device is able to manifest the content, dispatching the first version of the content to the client device.

12. A method according to claim 11 including the step of sending the technical attributes of the client device together with a request for the content to be sent to the client device.

13. A method according to claim 11 wherein the client device is selected from the group consisting of: a PDA, a mobile telephone, a desktop computer and a laptop computer.

14. A web server hosting a web page having at least one component of content, wherein machine readable labels are incorporated within the content specifying at least one class of capabilities required by a client device to manifest the component of content.

15. A server according to claim 14, wherein the machine readable labels specify a plurality of classes of client device capability, each corresponding to a different version of the content.

16. A server according to claim 15, wherein the server is adapted to implement instructions for providing different versions of the content in dependence upon the class of client device capability.

17. A server according to claim 16 wherein the instructions are in the form of a stylesheet.

18. A server according to claim 16 wherein the instructions are in the form of a transcode.

19. A server according to claim 15 wherein the server is adapted to dispatch one of a plurality of existing alternate versions of the content to a client device, each alternate version corresponding to a class of client device capability.
